(19) United States
(12) Patent Application Publication
(10) Pub. No.: US 2009/0064766 A1
(43) Pub. Date: Mar. 12, 2009

(54) METHOD AND DEVICE FOR MEASURING THE VISCOSITY OF NON-NEWTONIAN LIQUIDS, IN PARTICULAR ENGINE OPERATING MATERIALS

(75) Inventor: Monika Scherer, Reuteingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/883,088

(22) PCT Filed: Jan. 26, 2006
(86) PCT No.: PCT/EP2006/050451

§ 371 Date: Oct. 27, 2008

(30) Foreign Application Priority Data
Mar. 18, 2005 (DE) 10 2005 012 453.4

(51) Int. Cl. G01N 11/16

(52) U.S. Cl. 73/54.41

(57) ABSTRACT

A method and a device for measuring the viscosity of non-Newtonian liquids, in particular engine operating materials, a first and a second viscosity measurement being carried out using a viscosity sensor device, and a differing excitation of the non-Newtonian liquid taking place for the first and second viscosity measurement.

### FIELD OF THE INVENTION

The present invention relates to a method and a device for measuring the viscosity of non-Newtonian liquids, in particular materials used in engine operation.

Although the present invention is not limited to engine operating materials, the present invention and the problem on which is based are explained on the basis of the example of the engine operating material motor oil.

In monitoring non-Newtonian liquids, in particular liquid engine operating materials such as motor oil, a plurality of chemical and physical properties of the liquid can be used to monitor its “state.” An important criterion for evaluating the momentary state of the liquid is its viscosity η, which can be measured using a viscosity sensor. Simply put, the viscosity η of a liquid is the resistance that the liquid offers to kinematic excitation.

For measuring viscosity, for example piezoelectric thickness oscillators made of quartz are used. See for example S. J. Martin et al., Sens. Act. A 44 (1994), pp. 209-218. If such a thickness oscillator is immersed in a viscous liquid, the resonance frequency of the natural oscillation and its attenuation change dependent on the viscosity and the density of the viscous liquid. Because for typical non-Newtonian liquids the density varies much less than does the viscosity, in practice such a component acts as a viscosity sensor.

German Patent Publication No. DE 101 12 433 discloses a viscosity sensor system having a piezoelectric sensor device designed as a piezoelectric thickness oscillator that is situated completely in the liquid that is to be measured and that has electrical contact points for electrical controlling, these points being resistant relative to the liquid, and having electrical supply lines that are resistant relative to the liquid and that are connected on the one hand to a control/evaluation electronics unit outside the liquid and on the other hand to the contact points of the sensor device by a suitable conductive adhesive provided with metal particles.

The sensor surface is strongly stressed in particular when used in aggressive or corrosive non-Newtonian liquids, e.g. motor oil or transmission oil. When used in motor oil in particular, over time a coating forms on the sensor surface that changes the sensor properties. A group of viscosity sensors that are not sensitive to this is known from German Patent Publication No. DE 198 50 799. These are what are known as surface oscillators or shear oscillators, in which an attempt is standardly made to provide protection against corrosive or aggressive non-Newtonian liquids by passivating the substrate.

In what are known as Newtonian liquids, the viscosity 7 depends only on the pressure and the temperature. In contrast, in non-Newtonian liquids viscosity measurements are always dependent on the measurement methods used and the associated measurement parameters.

FIG. 5 shows a schematic representation of two examples of kinematic measurement principles for determining the viscosity of a non-Newtonian liquid.

In FIG. 5, reference character Z1 designates an outer hollow cylinder that is filled with a non-Newtonian liquid F.

Immersed in hollow cylinder Z1 is a solid cylinder Z2 that is capable of movement about an axis A. Measurement principle a) provides a rotation with constant speed about axis A. Measurement principle b) provides an oscillation with constant frequency about axis A.

FIGS. 6a, b show the dependence of viscosity η in measurement principle a) on the shear rate γ, and the dependence of viscosity η in measurement principle b) on the frequency ω.

FIG. 6a shows that in measurement principle a), the value of the viscosity η decreases as the shear rate γ increases. Here, shear rate γ is proportional to the angular speed of the rotation.

According to FIG. 6b, in measurement principle b) as the frequency of the oscillation increases the real part R of the imaginary viscosity η decreases, whereas the imaginary part I increases. In measurement principle b), besides the dependence on the frequency ω there is also a dependence on the amplitude of the oscillation.

A method for measuring viscosity known from laboratory technology is the Ubbelohde method (DIN 52562), in which gravity is used as the driving force. This method operates by approximation, with a shear rate γ that is approximately equal to 0.

In contrast, viscosity sensors as described in German Patent Publication No. DE 101 12 433 or in German Patent Publication No. DE 198 50 799 operate in a frequency range on the order of magnitude of kHz to MHz.

### SUMMARY OF THE INVENTION

In comparison with known solution approaches, the present invention for measuring the viscosity of non-Newtonian liquids, in particular engine operating materials, and the corresponding device, have the advantage that different factors that determine viscosity in the liquid can be distinguished.

The basic idea of the present invention is that in non-Newtonian liquids, in particular engine operating parameters such as e.g. motor oil, extremely important complementary information can be obtained by carrying out a plurality of viscosity measurements using different excitation parameters.

In, for example, a motor oil having a base oil and a large-molecular additive for improving viscosity (VI improver), this offers the advantage that on the one hand a change in the base oil, and on the other hand a change in the large additive molecules, can be acquired.

In general, when there is variation of the viscosity measurement parameters or of the viscosity measurement method, such a measurement supplies valuable additional information about the state of a non-Newtonian liquid having various factors that influence the viscosity, e.g. a heterogeneous liquid.

The subclaims contain advantageous developments and improvements of the subject matter of the present invention.

According to a preferred development, for the differing excitation the viscosity sensor and/or at least one excitation parameter is modified.

According to another preferred development, the first and the second viscosity measurements are repeated at predetermined times, and a time curve of the measurement result of the first and of the second viscosity measurement is stored.

According to another preferred development, the first and the second viscosity measurements are carried out in a motor oil that has a base oil and a macromolecular additive, the first viscosity measurement providing information about the base oil and the second viscosity measurement providing information about the macromolecular additive.

According to another preferred development, the viscosity sensor for the first and the second viscosity measurement is an oscillation sensor type, the excitation differing in the sensor dimensioning and/or in the excitation oscillation shape and/or in the excitation amplitude and/or in the excitation frequency.

According to another preferred development, the viscosity sensor for the first and the second viscosity measurement is a constant-movement sensor type, the excitation differing in the sensor dimensioning and/or in the shear rate.

### BRIEF DESCRIPTION OF THE DRAWINGS

Exemplary embodiments of the present invention are shown in the drawings, and are explained in more detail in the following description.

FIG. 1 shows a first specific embodiment of the viscosity sensor system according to the present invention.

FIG. 2 shows viscosity data of a heterogeneous motor oil obtained using the first specific embodiment of the viscosity sensor system according to the present invention.

FIG. 3 shows a second specific embodiment of the viscosity sensor system according to the present invention.

FIG. 4 shows viscosity data of the heterogeneous motor oil obtained using the second specific embodiment of the viscosity sensor system according to the present invention.

FIG. 5 shows a schematic representation of two examples of kinematic measurement principles for determining the viscosity of a non-Newtonian liquid.

FIGS. 6a and b show the dependence of the viscosity η in measurement principle a) on the shear rate γ, and the dependence of the viscosity η in measurement principle b) on the frequency ω.

### DESCRIPTION

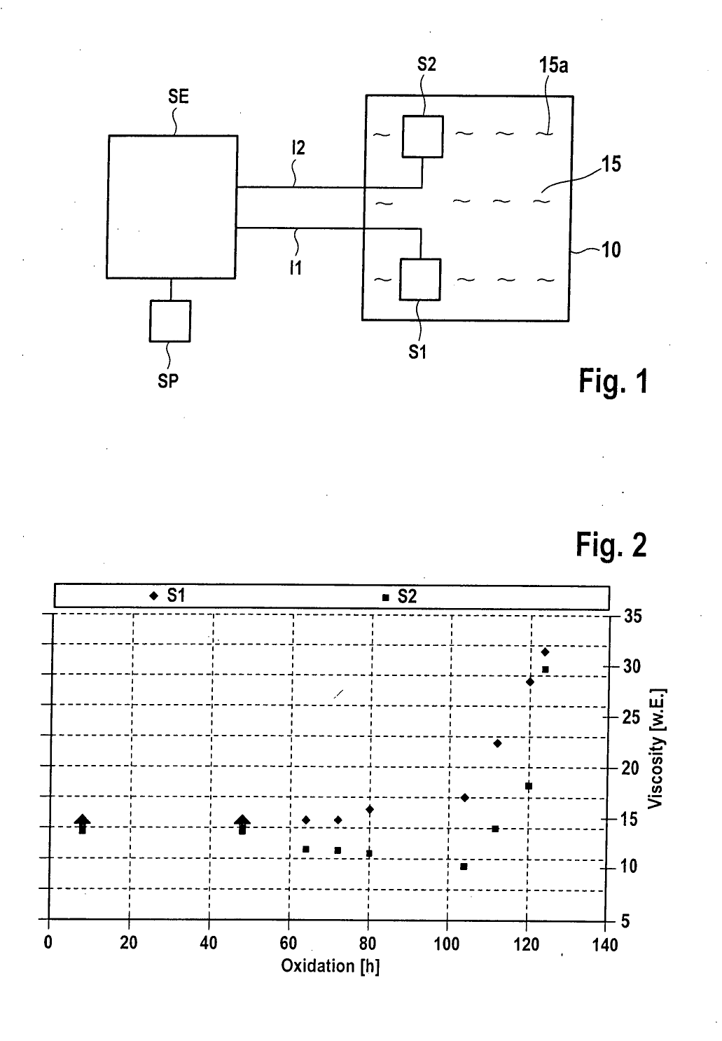

FIG. 1 shows a first specific embodiment of the viscosity sensor system according to the present invention.

In FIG. 1, reference character 10 designates an oil pan of a motor vehicle. In the oil pan, there is a base oil 15 having a large-molecular additive 15a. Immersed in motor oil 15, 15a are a first and a second viscosity sensor S1, S2. First viscosity sensor S1 is a microacoustic thickness oscillator, as is known for example from German Patent Publication No. DE 101 12 433. Second viscosity sensor S2 is a tuning fork oscillator.

First viscosity sensor 1 operates at a frequency of 1 MHz and an amplitude of 1 μm, whereas second viscosity sensor S2 operates at a frequency of 1 kHz and an amplitude of 100 μm.

Via lines 11, 12, a control unit SE controls the operation of the two viscosity sensors S1, S2.

In particular, at predetermined times values for acquiring the oxidation of motor oil 15, 15a are acquired and are stored in a storage device SP.

FIG. 2 shows viscosity data of a heterogeneous motor oil obtained using the first specific embodiment of the viscosity sensor system according to the present invention.

In FIG. 2, the rhombuses designate the measurement values of viscosity sensor S1, while the squares designate the measurement values of viscosity sensor S2. As can be seen in FIG. 2, viscosity sensor S1 here acquires the oxidation of base oil 15; for this reason, as the oxidation duration increases, a continuous increase in the measurement signal can be observed. In contrast, the measurement signal of viscosity sensor S2 at first decreases as the oxidation duration increases, before subsequently increasing with approximately the same steepness as the measurement signal of viscosity sensor S1.

The initial drop in the measurement signal of viscosity sensor S2 is due to the fact that the oxidation causes the additive macromolecules to be destroyed or broken into pieces, so that the viscosity first decreases with the alteration before increasing. This behavior of the macromolecules can however be acquired only by low-frequency viscosity sensor S2, which also has a large amplitude. This is because the macromolecules cannot follow the high-frequency oscillations with a slight deflection of viscosity sensor S1, and therefore remain invisible to this sensor.

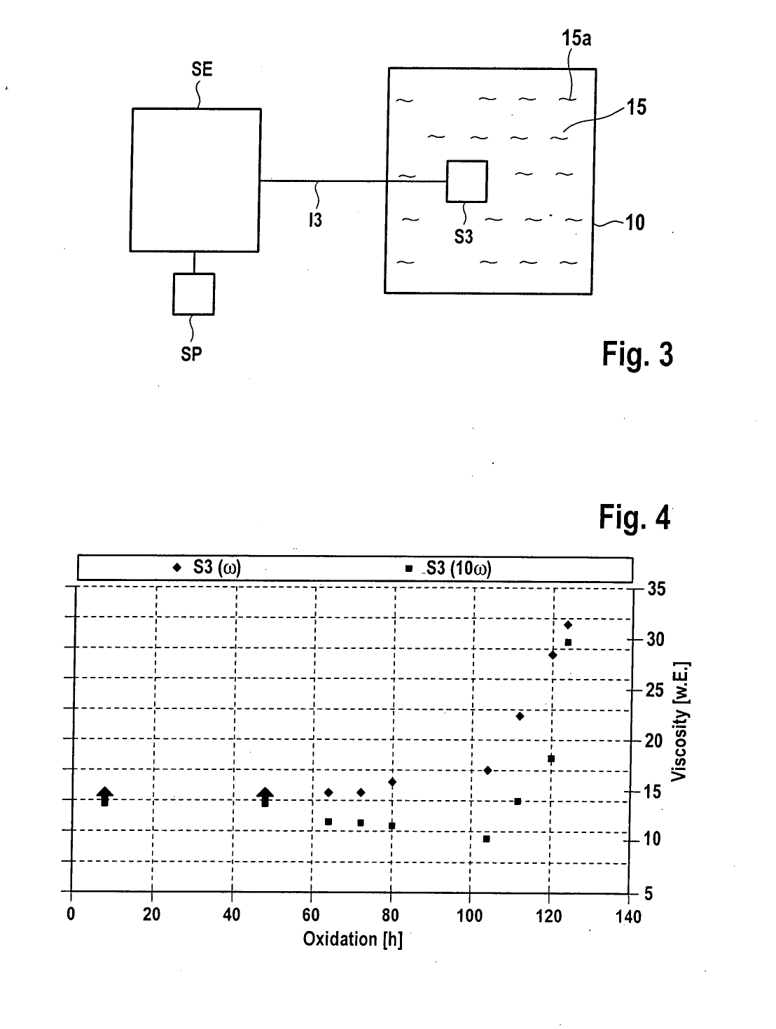

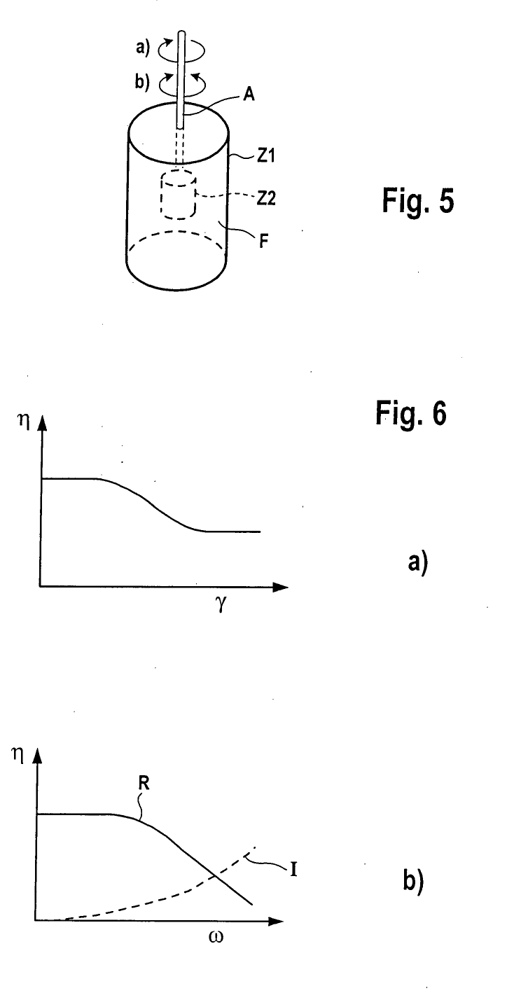

FIG. 3 shows a second specific embodiment of the viscosity sensor system according to the present invention. In the second specific embodiment shown in FIG. 3, a single viscosity sensor S3 is provided in motor oil 15, 15a that is activated via a single line 13 by control unit SE at predetermined oxidation times.

In this specific embodiment, viscosity sensor S3 is a microacoustic shear transducer according to German Patent Publication No. DE 198 50 799 that is excited on the one hand with its fundamental frequency and on the other hand with a harmonic overtone, here the 10th harmonic overtone. To this extent, viscosity sensor S3 provides supplementary information at the measurement points, namely information concerning the viscosity at the fundamental frequency and information concerning the viscosity at the 10th multiple of the fundamental frequency.

FIG. 4 shows viscosity data of the heterogeneous motor oil obtained using the second specific embodiment of the viscosity sensor system according to the present invention.

According to FIG. 4, the measurement values at fundamental frequency ω are designated by the rhombuses, and the measurement values at the frequency 10ω are designated by the squares.

Comparison with the first exemplary embodiment according to FIG. 2 shows that the measurement values almost coincide, and that information can be obtained about the base oil at high-frequency excitation 10ω and about the macromolecular additive at fundamental frequency ω. Here, frequency ω is 10 kHz, whereas the frequency of the 10th harmonic overtone is 100 kHz. In this example, the amplitude is the same for both excitations, i.e. for ω and 10ω.

Although in the above-described specific embodiments the viscosity sensors are a micromechanical thickness oscillator, a shear oscillator or tuning fork oscillator, the present invention is not limited to these. In the present invention, arbitrary microacoustic thickness oscillators, shear oscillators, and macroscopic oscillators may be used.

The indicated frequency and amplitude values are also intended only as examples, and are to be optimized with respect to the particular non-Newtonian liquid that is to be investigated in order to obtain the desired information.

### LIST OF REFERENCE CHARACTERS

10 oil pan
15 base oil
15a macromolecular additive
S1, S2, S3 viscosity sensor
SE control device
SP storage device
l1, l2, l3 lines
A axis
Z1, Z2 cylinders
F liquid
R real part
I imaginary part
ω frequency
γ shear rate
η viscosity

1-10. (canceled)

11. A method for measuring a viscosity of non-Newtonian liquids corresponding to engine operating materials, comprising:
performing a first and a second viscosity measurement using a viscosity sensor device, a different excitation of the non-Newtonian liquid taking place for the first and second viscosity measurement.

12. The method as recited in claim 11, wherein for the different excitation, the viscosity sensor and/or at least one excitation parameter is modified.

13. The method as recited in claim 11, wherein the first and the second viscosity measurement are repeated at predetermined times, and a time curve of the measurement result of the first and second viscosity measurement is stored.

14. The method as recited in claim 11, wherein the first and the second viscosity measurement are carried out in a motor oil having a base oil and a macromolecular additive, the first viscosity measurement supplying an item of information about the base oil and the second viscosity measurement supplying an item of information about the macromolecular additive.

15. The method as recited in claim 11, wherein the viscosity sensor for the first and the second viscosity measurement is an oscillation sensor type, and the excitation differs in the sensor dimensioning and/or in the excitation oscillation shape and/or in the excitation amplitude and/or in the excitation frequency.

16. The method as recited in claim 11, wherein the viscosity sensor for the first and the second viscosity measurement is a constant motion sensor type, and the excitation differs in the sensor dimensioning and/or in the shear rate.

17. The method as recited in claim 11, wherein the viscosity sensor device has at least one viscosity sensor from the following group: microacoustic shear oscillators, microacoustic thickness oscillators, macroacoustic oscillators.

18. A device for measuring viscosity of non-Newtonian liquids corresponding to engine operating materials, comprising:
a viscosity sensor device that has a first and a second viscosity sensor that are fashioned such that a first and a second viscosity measurement are capable of being carried out with differing excitation of the non-Newtonian liquid.

19. A device for measuring a viscosity of non-Newtonian liquids corresponding to engine operating materials, comprising:
a viscosity sensor device provided with three viscosity sensors, a third viscosity sensor being fashioned such that a first and a second viscosity measurement are capable of being carried out with differing excitation of the non-Newtonian liquid.

20. The device as recited in claim 19, further comprising:
a control device for causing the first and the second viscosity measurement to be repeated at predetermined times; and
a storage device in which a time curve of the measurement result of the first and second viscosity measurement is able to be stored.
